(19) United States
(12) Patent Application Publication
(10) Pub. No.: US 2010/0222066 A1
(43) Pub. Date: Sep. 2, 2010

(54) METHOD OF MANAGING RADIO RESOURCES IN A CELLULAR RADIO SYSTEM

(75) Inventors: Jiuhui Du, Beijing (CN); Bo Hagerman, Tyreso (SE)

Correspondence Address: HARRITY & HARRITY, LLP, 11350 RANDOM HILLS RD., SUITE 600, FAIRFAX, VA, 22030, US

(73) Assignee: TELEFONAKTIEBOLAGET LM ERICSSON (PUBL), Stockholm (SE)

(21) Appl. No.: 12/679,343

(22) PCT Filed: Oct. 9, 2007
(86) PCT No.: PCT/SE2007/050728

§ 371 Date: Mar. 22, 2010

(51) Int. Cl. H04W 72/04

(52) U.S. Cl. 455/450

(57) ABSTRACT

In a method and a system for managing resources within a cellular radio system servicing a geographical area, the serviced area is divided into at least two types and additional radio resources is provided to mobile stations located within one of the areas being deemed to be more sensitive for interference compared to mobile stations located within the other area.

### TECHNICAL FIELD

The present invention relates to a method and a system for managing radio resources in a cellular radio system.

### BACKGROUND

RRM (Radio Resource Management) is commonly utilized to handle the allowable radio resources in mobile communication, especially from the third generation systems. Radio Resource management includes management of many different resources within a cellular radio system including RA (Random Access). AC (Admission Control), CA (Code Allocation), HO (Hand Over), PC (Power Control), LC (Load Control)/CC (Congestion Control), and so on.

TD-SCDMA (Time Division-Synchronization Code Division Multiple Access) is one of the third generation mobile communication standards. Some advanced radio and processing technologies such as TDD (Time Division Duplex) mode, Uplink Synchronization, Smart Antennas, Joint Detection. Dynamic Channel Allocation are used in TD-SCDMA. Some of the advanced radio technologies used for TD-SCDMA makes radio resource management more challenging than in other third generation radio systems.

In TD-SCDMA, there is no soft handover like for example in WCDMA (Wideband Code Division Multiple Access). In TD-SCDMA, hard handover is supported: although some networks can support Baton hand over for dedicate channels in TD-SCDMA. Due to the lack of soft-handover in TD-SCDMA networks, users located close to a cell border will sometimes suffer from a bad QoS (quality of service). In some circumstances the QoS cannot be kept within specified limits and a user close to a cell border can not be served rightly and timely.

Hence, there exist a need for a method and a system that is able to improve the QoS in cellular radio systems such as TD-SCDMA. In such systems, there are lots of challenges to perform cell selection, random access, admission control, radio resource allocation and so forth

### SUMMARY

It is an object of the present invention to overcome or at least reduce some of the problems as outlined above.

It is another object of the present invention to provide a method and a system that is capable of providing an improved Quality of Service (QoS) for users in a cellular radio system.

It is yet another object of the present invention to provide a method and system that is capable of providing an acceptable Quality of Service for all mobile stations located within an area serviced by a cellular radio system.

These objects and others are obtained by the method and system as set out in the appended claims. Thus, in accordance with the invention, a multitude of cells of a cellular radio system are grouped together and available radio resource for all of the cells of the group is managed as a whole.

Also, in accordance with the present invention, a first area, where the inter-cell interference is a challenge for QoS guarantee is formed within an area covered by a group of cells. The remaining area of the group of cells will constitute a normal, second, area. Users located in the first area can be termed sensitive users and users in the second area can be termed normal users.

In accordance with one embodiment the Radio Resource Algorithm applied within the area formed by a group of cells is configured to give additional resources to sensitive users compared to normal users. In particular the Radio Resource Algorithm can be configured to optimize the number of users within the group that is given a Quality of Service that is at least equal to the minimum required Quality of Service for each user.

### BRIEF DESCRIPTION OF THE DRAWINGS

The present invention will now be described in more detail by way of non-limiting examples and with reference to the accompanying drawings, in which:

FIG. 1 is a view of a cellular radio system.

FIG. 2 is a view of a cellular radio system with sector configuration,

FIG. 3 is a view of a cellular radio system divided into different types of areas,

FIG. 4 is a view of a cellular radio system with a mobile station located close to the border of two cells.

FIG. 5 is a view of radio network controller RNC used to manage radio resources within cells controlled by the RNC, and

FIG. 6 is a flowchart illustrating steps performed when managing radio resources in a radio system using different radio resource allocation algorithms for different users.

### DETAILED DESCRIPTION

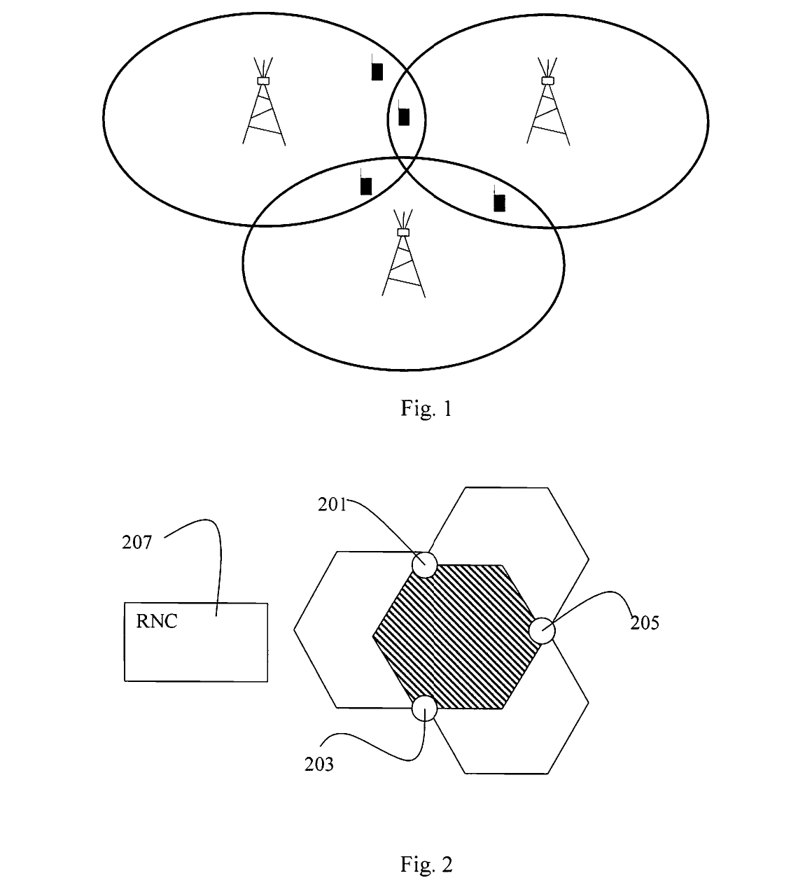

Typically, the primary challenge of RRM algorithms is to guarantee the QoS of users close to a cell border. This is because those users experience a radio link with a large path-loss towards the serving radio base station, Node-B, as well as they experience severe inter-cell interference. This especially for those users located in the overlapped area (two or more adjacent cells cover the area with similar path-loss towards the serving radio base stations) as shown as in FIG. 1. In fact, there are also small overlapped areas between sectors. i.e. the area close to the boundary of sectors.

For CDMA, with the property of self-interference, adjacent cells can be bundled into a group with common air interface resources wherein the radio resource allocation and management is performed in order to get a group-optimized balance of resource utilization among all of the cells of such a group of cells.

For instance, in accordance with one embodiment of the present invention under common sector configuration with 120° coverage, every three neighbour cells can be viewed as a resource-handling group covering a common area as the striped joint cell-area indicates in FIG. 2.

In FIG. 2, three radio base station sites are shown at 201, 203 and 205 respectively. The radio base stations 201, 203 and 205 are all connected to a radio network controller RNC 207. In a radio base station site configuration as the one shown in FIG. 2, the three cells served by the three radio base stations 201, 203 and 205 will suffer from interference signals generated by each other in the striped area. It is in general difficult to handle this type of interference at the air-interface in mobile network due to the complicated radio propagation characteristics. Therefore, these three cells are treated as a group for radio resource management in accordance with the present invention.

In order to obtain an improved Quality of Service within the cells depicted in FIG. 2, the coverage for a cell can be classified into different part, e.g. a sensitive area and a normal area. For TD-SCDMA, the sensitive area can be defined as the region close to the border of other cells due to a radio link with a large path-loss towards the serving Node-B and the severe inter-cell interference. Because there is no soft handover in TD-SCDMA. QoS for the users in the sensitive area may not be guaranteed in TD-SCDMA. Also, sometimes it is challenging to decode the broadcasted cell information and challenging to pass the random access procedure for these users to such degree that failures may be experienced. The remaining part of the cell is defined as the normal area, where these users has a good enough radio link with serving Node-Bs and their QoS is easily guaranteed by simple state of the art RRM algorithms.

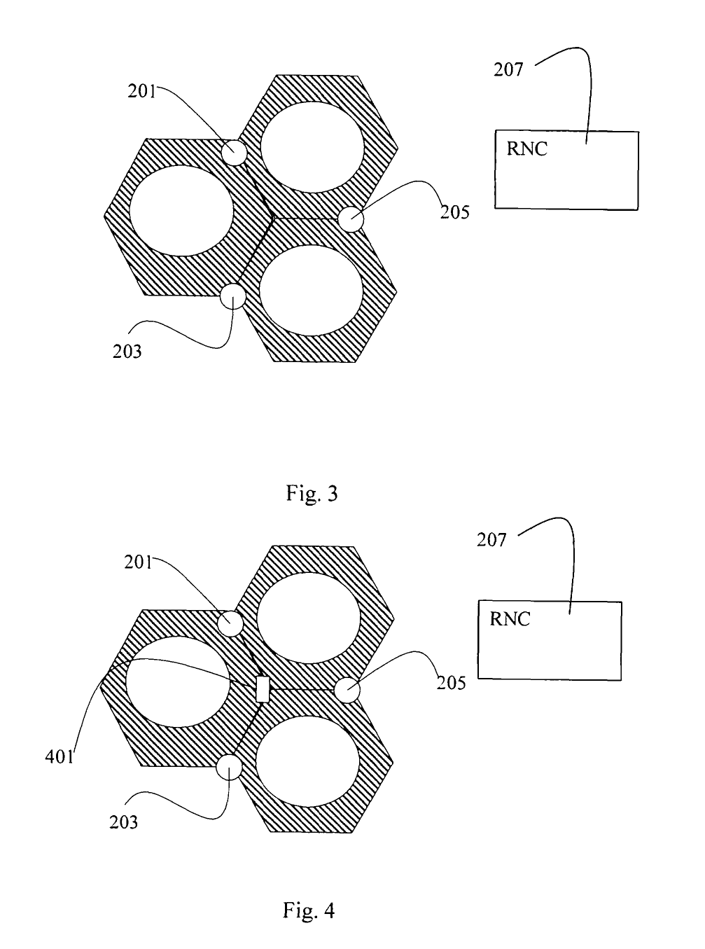

Hence, in an exemplary cellular radio system such as a TD-SCDMA radio system the sensitive area can be defined to correspond to the striped area in FIG. 3, i.e. areas being located some predetermined distance from the nearest radio base station, and the remaining area covered by such a radio system is defined to correspond to the non-striped area.

Different users within the coverage area of a radio system are then classified based on where in the coverage area of the radio system a user is located. Hence, users within the sensitive area can be classified as sensitive users whereas users within the remaining area covered by the radio system can be classified as normal users.

The users belonging to the different groups can then be treated differently for example by applying different RRM algorithms or different parameter setting. In particular, users in sensitive area can advantageously by given a more generous allocation of radio resources. This can for example be achieved by assigning, higher service priority to such users and/or applying adjusted thresholds reflecting the requirements in the specific situation for such users.

The principle of classifying an area serviced by a radio network into sensitive and normal area could be different based on the different requirement of network planning and optimization. For instance, the received broadcasted channel power level or the received dedicate channel power level, the CINR (Carrier-Interference-Noise Ratio), the BLER (Block Error Ratio), or the physical distance between the user and serving base station/Node-B, etc can be used to classify the type of areas within a joint coverage area served by a group of cells.

The Radio Resource Management functions applied in different scenarios may differ: For example after a Radio Network Controller of a radio system has gained knowledge about the classification of a mobile station, i.e. if the mobile station is regarded as normal or sensitive, the RNC may for example apply any of the following RRM algorithms.

When mobile station or User Equipment UE has a communication request, it will send the request to the current serving base station, and then execute a random access procedure for an attempt to access the radio network. For TD-SCDMA, the cell selection is typically based on received DwPCH (Downlink Pilot Channel) power level which is transmitted in the DwPTS (Downlink Pilot Time Slot). In such a scenario it is possible that a user receives two or more approximately equivalent DwPCH signal power levels from different cells in the same group if the user has similar distance to these base stations. Further, in such a scenario where a user receives approximately equal DwPCH signal power levels from more than one cell, the cell selection may result in that the selected serving cell is not the best one.

As a result a random access attempt to a particular cell may fail. In other words, the random access procedure has to deal with the challenges from users close to the border of two or more cells, i.e. the sensitive users.

To improve the likelihood of a successful random access procedure for a sensitive user, a radio resource algorithm allowing more chances to access more adjacent cells can be provided. For example, assume the scenario depicted in FIG. 4, where a user/mobile station 401 is located approximately equally close to the three base stations 201, 203 and 205 respectively. If the user 401 first tries to access the cell serviced by the base station 201 and fails, a subsequent attempt to access the radio system may be directed to another cell. In an exemplary embodiment, when the sensitive user 401 can not access a current cell by means of normal random access procedure with several sending preambles of SYNC_UL, i.e. one signal used in the Random access procedure of TD-SCDMA, but no feedback is received from the base station on the Fast Physical Physical Access Channel (FPACH), as well one signal used in RA procedure of TD-SCDMA, the user/mobile station 401 can be adapted to try to make an other access attempt to an other adjacent cells in the group of cells in some predetermined order.

In theory, the access success rate of a random access procedure is guaranteed by many things such as maximum transmission power of terminals, initial transmission power setting by open-loop power control, access attempt times and so on. But under any network deployment, there are random access failures due to the radio link variability when moving and similar events. This likelihood of a random access failure for a random access procedure is increased for the aforementioned sensitive users. Therefore, such users can be assigned additional radio resources in accordance with the above schematic description or for some other procedure giving priority to a sensitive user.

After a random access procedure, Admission Control (AC) and Dynamic Channel Allocation (DCA) will be triggered to decide to admit the user or not and assign the suitable radio resource units for bearer in for example TD-SCDMA. These two functions are important in

RRM in order to control system robustness and radio resource utilization rate. For TD-SCDMA, there is a close relationship between admission control and channel allocation due to its timeslot-based bearer characteristics.

In accordance with one embodiment of the present the invention, a multi-cell group based radio resource allocation scheme can be implemented by first applying a straight forward traditional algorithm like random allocation or similar conventional schemes and then to use an additional re-allocation scheme for one or more particular users, especially for sensitive users.

Typically, a particular user can be identified by reduction/changes in the measurement report of received power level on dedicate channels. The re-allocation algorithm can for example be build as a virtual priority-based resource allocation guard layer overlapped on the normal layer to guarantee the QoS of sensitive users. For example, a resource priority based algorithm can be used to deal with a user experience a very bad radio link and its QoS is lower than the minimum requirement for at least some predetermined period of time or if there is a risk of dropping the user.

For TD-SCDMA, the allowable radio resource units include carrier, time slot, channelisation codes. Spatial degree is additive handling resource if SDMA is used. If a User/mobile station, such as the mobile station 401 in FIG. 4 satisfies any condition triggering a re-allocation of radio resources, the network will re-allocate it to a pre-designated frequency or/and slot to guarantee its QoS. Because the primary interference in TD-SCDMA is inter-cell interference, different radio resource priority setting among the cells in a group can isolate effectively and minimize the inter-cell interference in the sensitive area.

For example, when the user/mobile station 401 satisfies any condition triggering re-allocation, the network will check its current assigned resource from every domain. Next, the network will try to re-allocate the highest priority resource units of its serving cells. In the above case, if the current slot is 3 but 1 is the highest priority slot, the system will attempt to transfer it to time slot 1. Given the user is already in slot 1: the system will try to transfer it to the carrier with the highest priority. If there is no resource with higher priority, the terminal may have to be dropped.

Based on the above resource priority setting scheme, the admission control and handover functions could be taken into account as a whole. That is, the admission control can be set to first estimate the admission effect for users with normal resource units and for users with prior/pre allocated resource units, and then set different weights to these two type of estimation results to decide to admit or not. The prior/pre allocation is a default allocation of all cell/cell group resources division to avoid or minimize inter-cell interference in a low load situation. Also, handover measurement can be made to pay additional attention to sensitive users, and the system can allocate the prior/pre allocated units to the handover users due to most handovers are triggered by bad QoS.

Moreover, Load Control LC and Congestion Control CC functions can be set to treat different users' individually. For example, the aforementioned re-allocation algorithm can be seen as a load control scheme for speech users depending on the definition of the relationship of overload and the triggering event for a re-allocation.

Typically, a down switch method, i.e. lower allocation of allowed bitrate, is used to avoid network congestion for packet switched PS traffic. In a preferred embodiment of the present invention, the network pays special attention to monitor the packet switched users in a sensitive area than users in a normal area. This may for example result in that either the sensitive user and/or the normal users are service down switched to support the prioritized sensitive users' services.

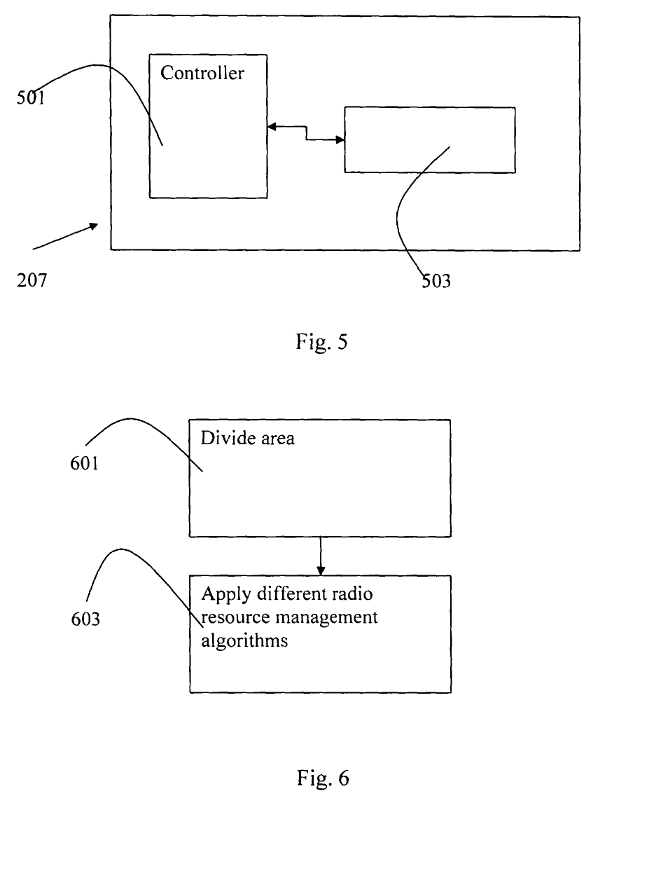

In FIG. 5 a view of an RNC 207 implementing a radio resource management algorithm in accordance with the above is shown. The RNC 207 may comprise a control unit 501 for managing the radio resources within the cells under control of the RNC. In addition the RNC may comprise a memory 503 for storing suitable software, in particular a computer program product that when executed by the RNC will cause the RNC to control the radio resources within the cells under control of the RNC in accordance with the program segments of the software of the program product.

In FIG. 6 a flowchart illustrating exemplary steps performed by the RNC 207 when applying a radio resource management algorithm in accordance with a preferred embodiment of the invention. First, in a step 601, the network divides a group of cells under control of the RNC 207 into at least two different area types. A first area where users of the radio network potentially will experience difficulties in maintaining a Quality of Service and a second area constituting the remaining area of the group of cells. Of course the area may be divided into more than two types if that should be advantageous in some scenario.

Next, in a step 603, all users within the first area will be serviced using a different radio resource algorithm than the users in the second area. In particular such a different radio resource algorithm may be any of algorithms as set out above.

Using the method and system as described herein will provide a better Quality of Service for users in a cellular radio system. In particular users located in areas normally suffering from a bad quality of service can be provided with an improved Quality of Service. In addition the risk of dropping connections will be reduced.

1. A method of managing resources within a cellular radio system servicing a geographical area, the method comprising:
dividing the serviced geographical area into at least two types, the at least two types including a first area where Quality of Service is deemed to be difficult to maintain based on some predefined condition, and a second area outside the first area, and
providing additional radio resources to mobile stations located within the first area compared to mobile stations located within the second area.

2. The method according to claim 1, where the geographical area served by the cellular radio system is divided into groups of cells associated with Radio Base Stations being controlled by a same Radio Network Controller (RNC), and
where the radio resources of each group is managed as one radio resource handling group.

3. The method according to claim 2, where the cellular radio system is configured with a common sector configuration with about 120° coverage, and
where every three neighbour cells is grouped as one radio resource-handling group.

4. The method according to claim 1, where the first area is defined as a region close to a border of radio cells handled by other radio base stations.

5. The method according to claim 1, where a different radio resource management (RRM) algorithm or a different parameter setting are applied for mobile stations located in the first area.

6. The method according to claim 5, where a higher service priority and/or reduced target thresholds are applied to mobile stations located in the first area.

7. The method according to claim 1, where a radio resource algorithm allowing additional opportunities to access at least one adjacent cell if a random access attempt to a current serving cell fails is provided for mobile stations located in the first area.

8. The method according to claim 1, where a different reallocation algorithm is applied to some mobile stations based on a measurement report of at least one dedicated channel.

9. The method according to claim 1, where a resource priority based algorithm is applied to a mobile station if the Quality of Service (QoS) is lower than a predetermined threshold value for at least a predetermined period of time or if there is a significant probability of dropping a connection to the mobile station.

10. A node for managing resources within a cellular radio system servicing a geographical area, the node comprising:
means for dividing the serviced geographical area into at least two types, the at least two types including a first area where Quality of Service is deemed to be difficult to maintain based on some predefined condition, and a second area outside the first area, and
means for providing additional radio resources to mobile stations located within the first area compared to mobile stations located within the second area.

11. The node according to claim 10, where the means for dividing includes:
means for dividing the geographical area served by the cellular radio system into groups of cells associated with Radio Base Stations being controlled by a same Radio Network Controller (RNC), and
where the radio resources of each group is managed as one radio resource handling group.

12. The node according to claim 11, further comprising:
means for grouping every three neighbour cells, of the cellular radio system configured with a common sector configuration with about 120° coverage, as one radio resource-handling group.

13. The node according to claim 10, further comprising:
means for setting the first area as a region close to a border of radio cells handled by other radio base stations.

14. The node according to claim 10, further comprising:
means for applying a different radio resource management (RRM) algorithm or different parameter setting for mobile stations located in the first area.

15. The node according to claim 14, further comprising:
means for giving a higher service priority and/or applying reduced target thresholds to mobile stations located in the first area.

16. The node according to claim 10, further comprising:
means for allowing additional opportunities to access at least one adjacent cell if a random access attempt to a current serving cell fails is provided for mobile stations located in the first area.

17. The node according to claim 10, further comprising:
means for applying a different re-allocation algorithm to some mobile stations based on a measurement report of at least one dedicated channel.

18. The node according to claim 10, further comprising:
means for applying a resource priority based algorithm to a mobile station if the Quality of Service (QoS) is lower than a predetermined threshold value for at least a predetermined period of time or if there is a significant probability of dropping a connection to the mobile station.

19. A computer program product that comprises program segments that, when executed on a computer, causes the computer to perform a method comprising:
dividing the serviced geographical area into at least two types, the at least two types including a first area where Quality of Service is deemed to be difficult to maintain based on some predefined condition, and a second area outside the first area; and
providing additional radio resources to mobile stations located within the first area compared to mobile stations located within the second area.

20. The computer program product of claim 19, where the geographical area served by the cellular radio system is divided into groups of cells associated with Radio Base Stations being controlled by a same Radio Network Controller (RNC), and
where the radio resources of each group is managed as one radio resource handling group.
